(19) United States
(12) Patent Application Publication
(10) Pub. No.: US 2026/0246415 A1
(43) Pub. Date: Aug. 20, 2026

(54) A cabinet or frame-mountable photovoltaic array for sub-optimal solar power conversion and methods and apparatus for maximising collection efficiency

(71) Applicant: Maurice Briggs, Norwich (GB)

(72) Inventor: Maurice Briggs, Norwich (GB)

(21) Appl. No.: 19/159,318

(22) PCT Filed: Feb. 23, 2024
(86) PCT No.: PCT/IB2024/051777

§ 371 Date: Aug. 24, 2025

(30) Foreign Application Priority Data
Feb. 23, 2023 (GB) 2302580.2

(51) Int. Cl. H02S 20/10; H02S 40/32

(52) U.S. Cl. CPC H02S 20/10; H02S 40/32

(57) ABSTRACT

The invention describes a photovoltaic (PV) power generator ideally suited for off-grid and remoted locations having a substantially upright structure and comprising an enclosure, adapted to be ground-engaging, upon which there is mounted a plurality of vertically disposed PV panels. The enclosure houses control circuitry for the harvesting, storage and delivery of electrical energy generated via the PV panels. Excess energy is accumulated in battery packs and delivered upon demand when supply via the PV panels is insufficient. The generator is optimised to a power rating ideal for off-grid living (average daily output of 200 Wh/day) and for sustaining a domestic dwelling during seasonal minima of solar radiation and is provided with sufficient PV energy harvesting area to deliver the average daily rated output.

### FIELD OF THE INVENTION

The present invention relates to the design and installation of photovoltaic cells or modules in an array to form a power generator apparatus, particularly suited for remote sites and latitudes where solar energy is unreliable or highly variable, especially from season to season.

In a first aspect the invention relates to an off-grid solar powered generator that provides consistent rated power in locations having high seasonal variance of solar energy, for example, in all latitudes of the United Kingdom (UK) in all seasons which does not necessitate a supplementary energy generation source and, in a second aspect relates to a hybrid grid generator which is connectable to additional power generators of the invention, supplementary power sources and/or mains power for regional or national grid infrastructure. Mainland UK lies between the latitudes of 50° N and 59° N and experiences a significant variance in the average angle of incidence of solar radiation between summer and winter. There are many other countries sharing similar northerly latitudes (including a major part of Canada, Northern Europe and a large swathe of the Russian Federation), however, only the southern tips of Chile and Argentina have notable population centres in the corresponding southern latitudes.

In a further aspect, the invention relates to an enclosure or unitary structure that is weatherproof, robust, easily maintained and is deployable or transportable to remote and off-grid locations to provide a useful daily power output in sub-optimal conditions, specifically during the months of lowest average harvestable solar radiation.

The terms “generator unit” and “unitary structure” as used herein are directed primarily to an enclosure or closed cabinet within which control circuitry is secured and protected against weather and interference by the curious. The term extends also structures adapted to support solar/photovoltaic panels and adapted to connect to ancillary sources of power, such as accumulator batteries, motor generators, wind turbine, amongst others, and, of course, the mains grid. The scope of the invention, however, is not intended to be so limiting and should be taken to include any ruggedised enclosure adapted to be deployed to remote locations and hoisted or otherwise elevated during its positioning at or recovery from a site. This is particularly relevant where the deployment or recover weight may be significant more than that of the unit when empty and applies equally to enclosures housing battery packs.

The terms “enclosure” and “cabinet” as used herein are intended to indicate a unit or construction made as a unitary power generator and which is adapted to be coupled to ancillary power sources and additional units (which may be formed into a bank or array).

Although the term “useful quantities” is used with reference to a desired daily power output from the generator unit during seasonal minima of solar radiation (November, December and January in northern latitudes), no limitation ought to be placed on the rated power of the apparatus as a whole which can be connected to and have its power output augmented by additional generator units or external sources, including mains power. Furthermore, the term “useful quantities” has specific meaning within different contexts as will be described hereinbelow with reference to the numerous uses to which the generator apparatus may be applied.

### BACKGROUND TO THE INVENTION

There are numerous methodologies and technologies utilised for extracting energy from the sun, each having their respective advantages and disadvantages depending on the application to which they are put and factors ranging from environmental impact to capital and maintenance costs.

One of the areas where most technological improvement has been made is in the sphere of harvesting, storing and distributing solar energy, collected via photovoltaic (PV) cells, most often arranged in banks of interconnected cells to form modules, with multiple modules making up a “solar panel”.

With exposure to nominal illumination by sunlight, each PV cell is capable of producing approximately 0.6V and when combined within a 72-cell panel is capable of yielding 300 W. Thus, a modular panel can deliver useful amounts of electrical energy in direct sunlight. This has become the de facto implementation for domestic roof-mounted systems and for commercial and large-scale “solar farms” comprising an array of ground-mounted panels for producing power for commercial enterprises from farms to data centres and for connection to national or regional grid power systems.

The factors regarding the harvesting of solar photovoltaic power referenced in more details below are different for commercial and large-scale implementation than for domestic and remote-site (or “off-grid”) implementations and it is in this latter area that the present invention is particularly concerned.

Capital cost of PV modules and panels has reduced markedly in recent years with the industrialization of printed PV cell technology and the ready availability of modules with integrated DC-DC converters and microinverters. With the reduction in the cost of harvesting solar energy and the need for a near constant supply of energy in off-grid and domestic applications (even at low or nominal levels), particularly where the cost of supplied energy may be prohibitive, focus must now be brought to the storage of generated energy.

Insolation is the term given to the amount of radiation or exposure at certain locations, however, in terms of harvesting solar energy, there are numerous factors at play. Of most significance is seasonal variation at particular latitudes where the intensity of solar radiation even at seasonal maximum is insufficient to provide useable levels of electrical power and additional sources must be utilised.

For any given latitude, an average or optimal panel angle may be calculated, however, with any selected angle towards the vertical there are factors to be considered such as structural strength to resist incident wind forces. Similarly, structural strength must also to be considered at panel angles towards the horizontal where snow loading becomes important. Obviously, a covering of snow severely impacts the harvesting of solar radiation. In less severe conditions, the settling of dust or debris on the panels means that panels require regular cleaning to maintain optimal harvesting.

It is well-established practise to align solar panels to an azimuth corresponding to a particular latitude or to select different azimuths in chosen panels in a solar array to account for seasonal variations.

The prior art is replete with structures and arrangements for tracking in the path of the sun to optimise the incidence of solar radiation on the receiving surface of the PV cells, however, irrespective of whether single-axis tracking is employed (for example, diurnal tracking) or dual-axis tracking following both diurnal and seasonal variations, all are at significant additional cost and inherent complexity. For remote transportable or at least moveable PV generators, robustness and service longevity is a must.

As will be readily appreciate from the patent literature, there are many different approaches taken to solving some of the technical disadvantages. Each area presents specific concerns, however, many aspects are common and will be addressed hereinafter.

It is acknowledged that within the prior art there are building and devices onto which PV panels have been secured in a vertical orientation. The primary expressed reason for doing to is that there are convenient vertical surfaces available and little real thought is given to their placement beyond convenience, it being considered a significant compromise to positioning on a vertical face. International Patent Application Publication No. WO 2023/019362 to SOLIDEL CANADA INC. discloses a vertical structure comprising a lamp post on which there is mounted a plurality of photovoltaic panels adapted to store solar energy collected during daylight hours to power a street lamp from a coupled battery during hours of darkness. The invention claimed is distinguished from earlier solar powered lamp posts by the provision of PV panels along the length of the structure rather than providing a panel or array angled according to latitude. By arranging a larger surface area of solar panel to be configured around the vertical riser of the post, the known disadvantage of insufficient power accumulation for illuminating a street lamp is addressed.

Chinese Patent Publication No. CN 107882364 to XIAOCHANG RUIKE INTELLEGENT TECH CO LTD describes a small outdoor seating structure having a sunshade in the form of an awning. Between a pair of bench seats, a table has a central column for supporting an electric cooling fan, powered from batteries stored within a seat base. At the top of corner support pillars, a horizontal solar panel forms a roof structure. An additional vertically disposed PV panel is connected to the roof panel and secured between two of the upright support pillars. The disclosure is directed only to the powering of the cooling fan.

United States Patent Publication No. US 2017/0141721 to SCHMIDT, ROBERT F describes a modular portable photovoltaic solar powered electrical generation, storage and supply device and light tower. The device consists of an elongated cube or rectangular prism shaped support structure with a flat base, flat sides and a flat decked top to form a protective crate shaped module when the various components, such as the solar panel arrays, telescoping mast, and light assembly or outriggers of the device are retracted to where the boundaries may be defined by the perimeters of the cube or prism. This modular design can allow for the modules to be stored, loaded, or shipped quickly, efficiently, and in greater quantities on flatbeds, in shipping containers, in warehouses, and other settings and modes where they can not only be packed end to end and side to side with no unused space, but can also be stacked up to three modules high for significantly higher storage density. The interconnectivity of multiple modules to create incrementally larger power generation, storage and distribution systems provides an easily adaptable solution to larger temporary power demands.

Chinese Patent Publication No. CN 107733067 to XIAOGAN QILE CREATIVE DESIGN CO LTD describes a solar charging shed comprising a structure (which may be used as a parking garage/shed for a vehicle) having support pillars for a roof-mounted solar panel and a side wall solar panel. The panels are connected to a battery pack which includes a current stabilizing device on which a charging interface is arranged. The shed facilitates the storage of solar energy within the battery bank for use charging the vehicle.

International Patent Publication No. WO 2003/012806 to SOLAR FENCE GROUP LTD discloses an architectural construction component comprising a prefabricated element on which a plurality of solar cells is mounted on solar cell carriers, in essence a PV panel. Surfaces of the PV panels include prisms or facets to collect solar energy from multiple angles. The solar cell carriers include lightweight transparent or translucent materials allowing the panels to be used on greenhouses. Constructions including vertically disposed PV panels or structures to which PV panels are secured in a vertical orientation are also disclosed for physical structural benefits as well as providing solar power.

International Patent Application Publication No. WO 2023/170416 to SOLIVUS LIMITED discloses a development of the solar electrical generator of International Patent Application Publication No. WO 2020/039181 also to SOLIVUS LIMITED utilising TFPV cells to obviate reliance on flat silicon wafer panels and similar technologies. Substantially as before, the invention relates to a solar electrical generator comprising an outer wall defining a cavity therein. The outer wall comprises a frame formed from a plurality of extrusions each having channels, the extrusions being arranged so that the channels on adjacent extrusions face one another. The objective being to provide back-to-back flexible solar panels between pairs of supporting extrusions.

United States Patent Publication No. US 2021/0075365 to COMMUNITY ADAPTATION, LLC discloses a PV power generating apparatus comprising a cubical unit to which multiple PV panels are attached by hinges allowing the PV panels to move between open, partially open and closed configurations. The unit includes wheeled or tracked assemblies for movement from location to location. The stated objective is to provide an alternative to fixed position installations, prioritising mobility, scalability and proofing against perceived vulnerabilities, including electromagnetic pulse (EMP) threat. The unit may also be configured as data storage pod retaining threat-protected data or personal information. Security protocols are described. The unit may be configured as a coffee table or sound system as a centrepiece for a home, campsite, office space or classroom. Additionally, the unit may also be configured as a trailer or provided with a seat for a driven embodiment.

Chinese Patent Publication No. CN 112910380 to ANHUI TIANZHU GREEN ENERGY SCIENCE & TECH CO LTD is directed primarily to addressing the perceived disadvantages of remote power generation and particularly the shortcomings of existing power box arrangements where battery storage is augmented by solar PV charging of the battery capacity on board, the perception being that installed photovoltaic capacity is generally insufficient thereby limiting the utility or promotion of the technology. The prior art cited within the disclosure introduces side wall PV components deployable to align with fixed PV assemblies on the top surface of the container to improve the PV capacity of the arrangement but notes that where support structures are required for the deployed side wall components, there are additional overheads relating to transportation and skilled personnel. Where additional PV capacity is provided by PV assemblies that can be slid and retracted, a deployment configuration where three times the capacity of the fixed top surface capacity can be achieved. Further prior art arrangements discuss the use of wind turbines to augment the PV generated capacity. Each of these arrangements has perceived technical disadvantages which the disclosure seeks to address.

In the illustrated embodiments of Chinese Patent Publication No. CN 112910380, a first PV component is laid flat on the roof of a container system with auxiliary PV components arranged to deploy by means of a push rod from each side wall thereof. In an exemplifying embodiment, adapted to maximise the capacity of PV generation, each auxiliary PV component has a further component stowed thereon and which is deployed therefrom. Optionally, the further component deploys synchronously with the auxiliary component via a coupled rotational drive. The push rod mechanism may comprise an electric push rod, an electro-hydraulic push rod or a hydraulic push rod.

It will be appreciated by those skilled in the art that the full deployment of PV components of Chinese Patent Publication No. CN 112910380 would require retraction when wind velocities exceed a safety parameter to prevent damage of the components or the push rods mechanisms. In windy environments, the full capacity of the power box will be realised only occasionally. The mechanical complexity, capital construction and maintenance costs together with the vulnerability in situ to damage associated the deployed configuration make it unlikely that the power box of the illustrated embodiments present the sought-for long-term solution to remote power generation needs.

It is an object of the present invention to seek to alleviate the disadvantages of the prior art arrangements and to provide a solar power generating apparatus for remote and off-grid locations which is robust and of enhanced durability.

It is a further object of the present invention to seek to provide a solar power generating apparatus having additional features which in combination provide superior utility and functionality on location.

The invention is also directed to achieving a balance of physical, environmental, financial and electrical constraints that represents the best overall compromise to provide a “useful amount” of electrical power each day of the year, irrespective of season, weather conditions and cloud cover, optionally independent of external power sources and away from a fixed source of power (such a mains grid power).

Ideally, the power generating apparatus of the invention achieves its objective via a single source of power, that is, via solar radiation with battery pack accumulation for delivering power during the night. The apparatus may also be used with a wind turbine to augment power generation and storage.

Preferably the apparatus is connectable to standard mains infrastructure of an existing building to provide alternative, emergency or back-up power in a domestic or off-grid setting. The apparatus may also be used as an alternative feed or to augment power supply in areas likely to be cut-off from national or regional mains supply.

### SUMMARY OF THE INVENTION

In a first aspect of the present invention there is provided a photovoltaic (PV) power generator on which PV panels operably form at least one two of the major faces thereof to optimise the harvesting of solar radiation in sub-optimal conditions with respect to diurnal and seasonal variances of direct and indirect incidence of solar radiation., the generator comprising:
a cabinet housing having structural frame elements and a ground-engaging element attached thereto; and
sealingly disposed within the housing, control circuitry for regulating the electrical energy generated via the PV panels and energy accumulators connected to the control circuitry;
in which at least two PV panels are disposed on said major vertical faces of which at least one is directed towards the arc subtended by the sun (due south in northern latitudes) and at least one is disposed substantially perpendicular thereto,
   whereby for reduced mechanical and financial overhead, the harvesting of PV energy is physically optimised across all seasonal and diurnal variances.

In a preferred construction, PV panels are disposed on each of said major vertical faces. In the majority of the embodiments described herein below, the shape of the cabinet is substantially cuboid but with a tilted roof section. Although each of the major faces may be equal in area, it is preferred that the faces directed towards and away from the arc subtended by the sun are equal and twice the area of the remaining major faces (being substantially perpendicular thereto in a cuboid configuration). It will be appreciated that the shape of the cabinet may be a trapezoidal prism where the faces directed towards and away from the arc subtended by the sun are not equal.

Optionally, the PV panel mounted on the roof section extends over the major face facing away from the arc subtended by the sun.

Advantageously, the PV panel mounted on the roof section is pitched towards the optimal tilt angle (TW) at winter equinox (EW).

In a preferred construction, the structural frame elements are integrally formed with the PV panels.

Advantageously, the energy accumulators comprise a first bank of batteries having deep-cycle characteristics and a second bank of batteries having high power delivery characteristics and wherein combining cell technologies with charge controllers and voltage monitoring circuitry optimises both charging and delivery of power in sub-optimal conditions.

In a preferred arrangement, the first battery bank comprising a working bank of frequent and deep cycling cells, having superior weight to kWh ratios and the second battery bank comprising a reserve bank providing additional charging capacity and lower charging temperature capabilities that the working bank cells, each bank having charge balancers to compensate for charge state differences during a charging and discharging cycle.

Advantageously, the first battery bank comprising lithium ion or lithium iron phosphate batteries and the second battery bank comprising Absorbent Glass Mat (AGM) cells, each provided in a configuration associated with the required system voltage.

In a first preferred alternative construction, the housing has a box-like form in which structural frame components provide the peripheral corners thereof and the PV panels are secured therebetween to form the outward faces of an enclosure cabinet.

Ideally, the total surface area of PV panel is optimised to generate a daily average power generation of at least 200 Wh.

In one exemplifying construction of the invention, the generator apparatus is ruggedised to be transportable, easily serviceable in the field and incorporated features making the apparatus highly resistant to inclement weather.

Optionally, ground-engaging elements include lockable bogey wheels allowing the apparatus to be positioned accurately before securing.

Alternatively, the ground-engaging elements comprise securing plates through which anchor bolts or ground screws are fixed.

Advantageously, each PV panel is attached to the enclosure by a demountable frame adapted to encapsulate the PV panel and provide routing for cables associated with each panel.

In a preferred construction, PV panels are mounted within frames adapted to connect to one another and form at least two faces of the enclosure.

Ideally, the structural frame elements comprise extruded profiled components having rebates and channels to accommodate and retain PV panels and associated cabling.

Advantageously, the frames releasably retain the PV panels and include hinge elements at their peripheries to facilitate access to the interior of the enclosure.

Each face has a PV panel thereon has associated therewith a dedicated and appropriately rated charge controller to manage the solar power harvested from each panel within a face to maximise the efficiency of the charging output generated.

The energy accumulators delivers a direct current (DC) power output to devices or a local power connector or via an inverter to provide an alternating current (AC) power output.

The invention yet further provides a kit of parts for a solar generator apparatus or for an enclosure, each as defined hereinabove, the kit of parts comprising:
a selected number of PV panels mounted within frames in a selected configuration;
a charge controller rated to the maximum voltage and current generated for each presented face of the framed panels to match the power conversion algorithms of the controller; and
a manual isolating switch, automatic circuit breakers, fusing and bus bars to provide selected and fault-triggered isolation and operationally aggregate charge from the charge controllers to battery cell terminals.

Advantageously, the PV panels include toughening layers on all faces to maximise indirect yield of solar radiation.

The panel frames may comprise extruded profiles of stainless steel for rigidity and strength or of aluminium for a combined characteristic of strength with light weight.

Ideally, pairs of PV panels are mounted in a single frame and electrically connected in series to maximise the generated voltage.

The kit of parts further provides, for high demand applications and where AC power is required:
a discrete DC charge controller; and
an inverter with manual isolation switch.

Optionally, there is additionally provided a first working battery bank comprising lithium ion or lithium iron phosphate batteries and a reserve battery bank comprising Absorbent Glass Mat (AGM) cells, each provided in a configuration associated with the required system voltage.

For applications involving consistent, year-around usage with either AC or DC powered devices:
a deep discharge working bank is sized to 250% of the maximum daily Wh load to ensure a bias towards discharging the working cells to less than 40% of capacity to maximise their service life longevity.

For applications for servicing multiple low-load devices (rather than fewer high-load devices) a combined solar charge controller and inverter is provided per devices, that is one per PV panel face, with standby mode function to minimise background load.

### BRIEF DESCRIPTION OF THE DRAWINGS

The present invention will now be described more particularly with reference to the accompanying drawings which show, by way of example only, exemplifying embodiments of solar cabinet and frame-mountable solar generator comprising a plurality of solar photovoltaic panels fixed thereto with illustrations of supplementary components therefore. In the drawings:

FIG. 1 is an illustrative representation of an exemplary prior art arrangement of small-holding power supply source utilising an array of photovoltaic (PV) panels wired in a daisy chain configuration to a controller enclosure or cabinet and having an optional or back-up power source such as a wind turbine;

FIG. 2a is a diagrammatic illustration of the path of the sun in the UK at both the winter and summer equinox (solstice) and the corresponding optimum angle for the position of solar panels;

FIG. 2b is a bar chart showing the average levels of direct and indirect solar radiation that is usable by solar panels for each month of the year at a latitude corresponding to London, United Kingdom (51.5° N);

FIG. 3 is a perspective elevation of a first embodiment of solar power cabinet in accordance with the invention having a PV panel located on each external face of the cabinet;

FIG. 4 is a schematic illustration of components of control circuitry housed within the cabinet or enclosure;

FIGS. 5a and 5b are an angled side view and a perspective elevation respectively of an enhanced construction of a first embodiment of solar power cabinet having a PV panel located on each external face of the cabinet;

FIG. 5c is an exposed perspective elevation similar to that of FIG. 5b in which accumulator cells and control circuitry is disposed in an alternative configuration ;

FIGS. 5d and 5e are perspective elevations of a further construction of the first embodiment of solar power cabinet having a substantially equal PV panel area presented on each external face of the cabinet (each face being provided with a MPPT);

FIGS. 6a to 6c are perspective elevations of various constructions of framed PV panel;

FIG. 7 is a perspective elevation of a remote monitoring station;

FIG. 8 is a perspective elevation of a generator apparatus of the invention combined with a heat pump;

FIG. 9 is a perspective elevation of a variant of the first embodiment of PV power generator apparatus having a plurality of securable receiving receptables for receiving and charging removeable EV batteries;

FIGS. 10a and 10b are a detailed side view and a perspective elevation of a construction of generator apparatus similar to that shown in FIGS. 5d and 5e having a pivotable roof section to present a combined landing and charging platform for an autonomous electric vehicle (drone);

FIG. 11 is a perspective elevation of a generator apparatus having enhanced security features; and

FIG. 12 is a perspective elevation of a generator apparatus having attached to a minor face thereof a communications module which optionally comprise a cellular base station or signal repeater.

### DETAILED DESCRIPTION OF THE DRAWINGS

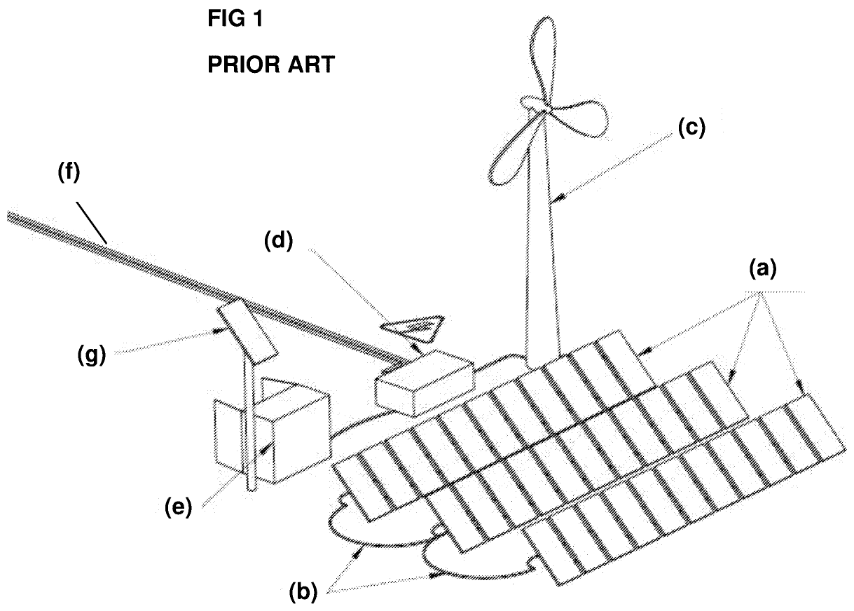

Referring to the drawings and initially to FIG. 1 which shows, as exemplifying of the prior art, a power generator assembly for supplying electrical energy for a smallholding or isolated domestic dwelling and comprises an array of solar panels (a) set out as three banks connected in daisy-chain configuration via cable connectors (b). The panels are fixed at a tilt angle corresponding to the site latitude and face in a southerly direction for northern hemisphere sites. To augment the input from the solar panels (and provide additional power during the hours of darkness), a wind turbine (c) is provided. For larger power generation plants, turbines operating at medium and high voltages provide solutions with lower cost per installed kW whereas the cost of small wind turbines (SWTs) are often two to four times more costly per installed kW due to the relative immaturity of the SWT market. Many “micro wind” installations, that is, those having a rotor swept area of less than 40 m² have a rated power of between 1kW and 7 kW. A 6 kW turbine is capable of generating up to 9000 kWh annually.

A typical domestic home uses approximately 11,000 kWh of electricity annually which equates to approximately 30 kWh daily consumption.

The direct current (DC) outputs of the PV panels (a) and wind turbine (b) may be routed through a fixed power output junction box (d) to a battery bank housed within an enclosure (e) within which voltage regulators, monitoring and control electronics is also housed in a weatherproof cabinet. Power inverters may also be found within the enclosure (e) or optionally within the junction box (d) where a power feed (f) couples the power generation assembly to the demand. Mounted on a pole attached to the enclosure a supplementary PV panel (g) for the control electronics is provided.

As noted in the preamble, this arrangement has numerous disadvantages particularly for remote site locations and off-grid living demands, where robustness and serviceability are essential requirements.

The configuration of the prior art does not readily lend itself to small domestic or off-grid applications and is unsuitable for power hubs for charging electric vehicles.

As detailed hereinabove, there are notable diurnal and seasonal variances in the angle of incidence of direct solar radiation on a surface. The primary diurnal influence is the arc made by the sun (with respect to incident surface, that is, a static PV panel) during the course of the day between sunrise and sunset. Additional diurnal variances include cloud cover and shadows from adjacent vegetation or structures (such as buildings but may include other PV panels in an array). The tracking of the sun's arc using an automated tracking mechanism to retain the plane of the PV panel perpendicular to the sun overcomes much but not all of the diurnal variances but add significant overheads to the harvesting of electrical power. For static PV panels, to maximise the collection of incidental radiation they should face directly south in northerly latitudes and north in southerly latitudes, that is, positioned in an east-west plane.

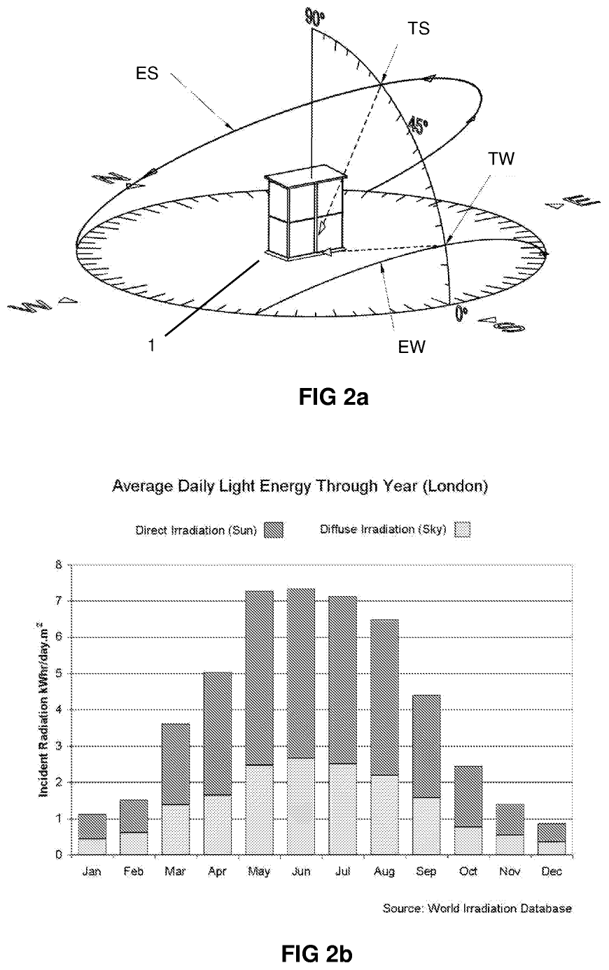

To account for seasonal variances, the angles to which the PV panels are tilted depends on the latitude of the site. In FIG. 2a, an enclosure 1 is centrally disposed within a circle on which the four cardinal directions N, S, E, W are indicated. A first line ES indicates the elevation of the daily path of the sun at the summer equinox and represents the optimal pitch or tilt TS of a PV panel to collect the maximum available solar radiation at that time of year. Similarly, a second line EW indicates the significantly lower elevation of the sun's path at the winter equinox but represents nonetheless the optimal tilt TW a PV panel to harvest solar radiation at that time of year. For a static PV panel, it is likely that the optimal tilt angle will be represented by the median of the two extremes (represented by the lines ES, EW and their corresponding tilt angles TE, TW) which will be closely aligned to the vernal and autumnal equinoxes.

In calculating the available energy that can be harvested from solar radiation it is important to distinguish between “direct irradiation” where a panel is collecting light from the sun and “diffused irradiation” where a panel is collecting light energy that has been scattered primarily by clouds or reflected/ambient light. In FIG. 2b, a bar graph showing both the direct and diffuse monthly radiation averages each month of the year at a location 51° N (London UK) measured as the average daily kilowatt hour energy incident per meter squared (k Wh/day·m²). From this example, the average daily direct light available will generate approximately 0.5 kWh to 0.75 kWh of energy per meter squared of exposed PB panel during the months of November, December and January. Furthermore, the ambient or diffuse average does not exceed 1 kWh per meter squared of available PV panel for any period between October and February.

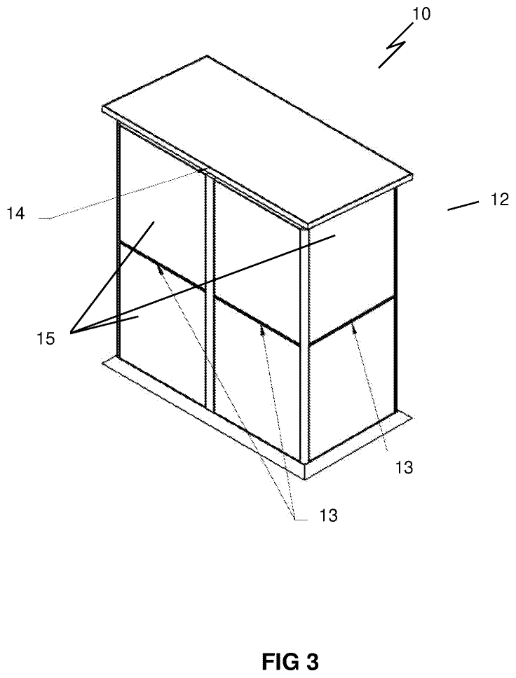

It is possible to take the combined daily average of the direct and indirect (ambient, diffuse or reflected) illumination and calculate a minimum area of PV panel required to achieve a nominal rating for an array or assembly of PV panels. Referring now to FIG. 3, a first embodiment of solar power generator apparatus 10 is shown and comprises a cabinet 12 defining an enclosure and having four planar faces 13 and a roof section 14.

In its most basic iteration, the apparatus comprises a cabinet to which vertically disposed PV panels 15 have been fixed to the front, rear and side faces, the front being a southerly facing surface in northern latitudes and has a total area of receiving PV panel to provide the rated output. For low output requirements, average daily winter output may be as little as 200 Wh which may be sufficiently to charge many electronic devices or, in one highly specific application of the invention, is used to maintain an operational current for recording, storing and transmission of collected data at a remote monitoring stations. The energy harvested may be augmented by the placement of reflectors angularly deflecting direct incident light towards the receiving panels. In a preferred construction, the roof 14 comprises a PV panel which may be pitched to optimise harvesting of solar radiation and/or prevent accumulation of snow and leaves thereon.

In a modified orientation of an enclosure having a rectangular cross-section, the front face is directed eastwardly towards the rising sun and the rear face is disposed towards the setting sun to maximise the area of incidence during the winter months and allow the southerly facing side and roof panel to collect the available light during the daily maxima.

The cabinet forms an enclosure for energy accumulation via storage battery banks and energy management or control circuitry. In the basic embodiment illustrated in FIG. 3, there are seven PV panels 15 disposed across five faces (two sides, front, rear and roof).

The PV panels are designed and rated to withstand harsh environmental conditions. In the case of a cabinet formed of extruded or profiled aluminium frame components, the resulting enclosure will have good corrosion resistance characteristics and be able to withstand heat and UV extremes. Anodized stainless steel is a preferred material for the production of an enclosure in which the panels are secured to an existing face via attachment of a border frame.

A number of environmental management features are integrated to allow the cabinet to exist within potentially quite extreme outdoor settings.

Discrete vents, protected internally by a fine internal mesh (to prevent insect ingress) are either built in to the roof frame or below the roof panel to allow hot air and any gas generated from charging the batteries to escape. Equivalent vents can be placed in the base or in the support floor to allow ingress of cool air to circulate. This feature can be supplemented with an automated and temperature-triggered waterproof cooling fan to improve the flow of air from base to top. Where there is a likelihood of operational temperatures exceeding thermal limits for the internal components, a series of fans may be triggered as predetermined thresholds are reached. An additional optional feature directs a flow of air across the PV panels to reduce surface temperature to minimise negative temperature coefficients where power generation of the PV panels may be reduced beyond that utilised by cooling fans.

An earth rod (not shown) can be placed before installation of the enclosure and connected to the frame components to allow the enclosure and equipment within to be electrically earthed, with connections from the cabinet and internal frame provided. Where ground screws are used to secure the cabinet, these may be used as part of earthing the generating apparatus.

In the case of cabinets deployed to more extreme low-temperature environments, fluted corrugated plastic sheet in isolation or in combination with a commercial insulation material can be used to reduce temperature extremes within the cabinet, allowing the equipment and cells more operational range within their design parameters. An air gap between the external panel face and frame components may also be provided to prevent thermal bridging.

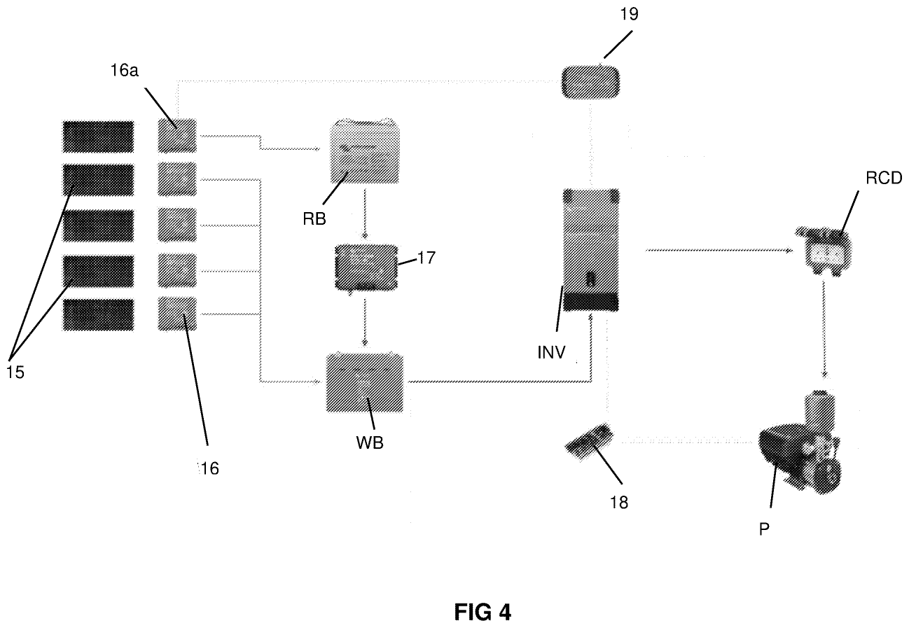

As illustrated in FIG. 4, the seven 100 W PV panels (only five are shown) are connected to charge controllers 16 for each face so as to regulate the charge current provided to the battery cells. In the exemplary construction, one of the charge controllers 16a (associated with one PV panel, hereinafter identified as the “top panel”) is connected to a reserve bank RB of deep-cycle batteries of the type described herein and capable of charging below 5 C. The remaining four charge controllers 16 channel harvested power from the remaining panels to charge a bank of batteries (designated the “working bank” WB) ideally comprising lithium ion or lithium iron phosphate (LiFePO4) cells both known to have excellent power characteristics. Power converted from DC to AC through a 2 kW inverter INV provides mains voltage via a breaker RCD or directly to a domestic dwelling consumer unit. In the embodiment shown, the output voltage is used to power a Grundfos CMBE AC boost pump P for maintaining water pressure in a feed.

The reserve bank RB powers an isolated DC to DC charger 17 which maintains an operating voltage across the individual batteries of the working bank WB. The DC to DC charger 17 is a 30 A unit designed to charge the working bank WB if individual battery voltages drop below 12.5V when the reserve bank battery voltages are over 11V.

Associated with the inverter is an actuation sensor 18 which enables a lower power standby mode. A remote monitoring unit 19 measures working and reserve battery voltages and inverter load and may include a communications module for alerting the user or a maintenance contractor. Advantageously, a pressure sensor is provided to automatically start and stop the boost pump P thereby optimising the available power.

It has been noted that with solar panels 15 feeding multiple charge controllers 16, where the PV panels each perform differently on each face with both diurnal and seasonal variations, an opportunity is presented to combine cell technologies to leverage their respective strengths and compensate for their respective weaknesses. By combining cell technologies within a generator circuit of the kind presented by the invention, it is possible to increase the longevity of both cell technologies and this is especially relevant with frequent cycling or frequent load applied particularly through the summer months.

Advantageously, the working bank WB comprises lithium ion or lithium iron phosphate cell batteries connected together in series to create the required circuit voltage (for example, two 12V batteries to present a 24V circuit). Further batteries may be connected in parallel to provide additional capacity to the working bank where required. A charge balancer can be used to ensure that charge state differences between the cells are compensated for during the charging process.

In a preferred configuration, as detailed hereinafter, each face of the charging station is optimised to feed a 48V battery pack within a battery bank, whereby PV panel voltages at full insolation generate open-circuit voltages of 60V and an approximate voltage of 51V under load, that is, the charging voltage for the respective battery packs.

Commercially available lithium ion and lithium iron phosphate cell batteries often feature in-built protection circuitry, cycle more deeply and more frequently than alternative technologies and have more favourable weight to k Wh ratios compared to alternative technologies.

It is noted, however, that these batteries can over time degrade between charge states of 80% and 100%, is expensive per Wh compared to other battery technologies and has poor charging characteristics below 5 C.

Absorbent Glass Mat (AGM) cells making up the reserve bank RB are connected together in series to create up to a 48V circuit. The AGM batteries may also be connected in parallel to create additional capacity where required but with a limit of 3 parallel batteries per bank. A charge balancer is always used to ensure that charge state differences between the batteries are compensated for in the charging process. An over-current protection device is installed on the circuit to compensate for the lack of in-built protection features.

It is noted that AGM batteries do not tend to degrade with charge states of 100% over longer periods of time (as compared to lithium-base batteries), are inexpensive per kWh of capacity compared to other technologies, can charge at temperatures below 0 C and have deep discharge characteristics where they are capable of discharging up to 40% of their capacity daily for over 1,000 cycles before they start to degrade. In contrast, however, if frequently cycled at rates of more than 40% discharge for periods of over 2 hours, the battery cells can degrade more rapidly.

It is also during winter minima that the lowest temperatures are likely to be experienced so it is crucial to focus charging on the batteries having the lowest operational temperature range.

It will be appreciated by the skilled addressee that, as battery technologies improve and operating and charging characteristics allow for better performance, the exemplar figures provided above may change.

As shown in FIG. 4, the working bank WB of lithium-based batteries are charged directly from the charge controllers 16 with the exception of the charge controller 16a associated with the top panel which is connected to the reserve bank RB. The panels selected to charge the working bank WB are those which will receive the maximum solar radiation during winter minima and therefore retain as best as possible a bias towards their full charge state.

In the case where there is frequent daily cycling of the AGM reserve bank RB, there is a benefit to adding a lithium-based or alternative frequent cycling or sacrificial battery to charge from the top panel charge controller 16a, directs the majority of the cycling to this battery, reducing the depth of discharge the AGM cells experience and decreasing the time at which the lithium cells sit at a fully charged state. The isolated DC to DC converter (or charger) 17 is used to transfer energy from the lithium batteries of the working bank WB to the AGM batteries of the reserve bank RB and must be sized to charge at a rate that is as close to the rate of discharge of the AGM batteries as is achievable. The voltage drop the working bank WB experience when a load is connected via the inverter INV triggers the charging process from the reserve bank RB which continues until either the working bank batteries are fully charged or the reserve bank is depleted.

This approach reduces cycle depth of the working bank batteries, increasing their longevity whilst decreasing the time the reserve bank spends at 100% charge state, also increasing its longevity. This arrangement also directs stronger summer solar yields from the top panel to the reserve bank batteries allowing them to cycle more often and recover more quickly when solar energy is more abundant, again reducing cycling on the working bank. Advantageously, the solar panels that produce the most yield in winter to charge the bank that actually powers load, need not use energy at solar minima to retain the temperature of the working bank cells within an operational range. The energy overhead to heat the lithium cells to absorb a charge or convert energy via the DC to DC charging process at a time when energy is least abundant is therefore obviated.

The utilisation of dual cell technologies to optimise harvesting at solar minima provides additional capacity in a given system economically reducing the overall cost of the system without incurring any of the concessions a single cell technology would entail.

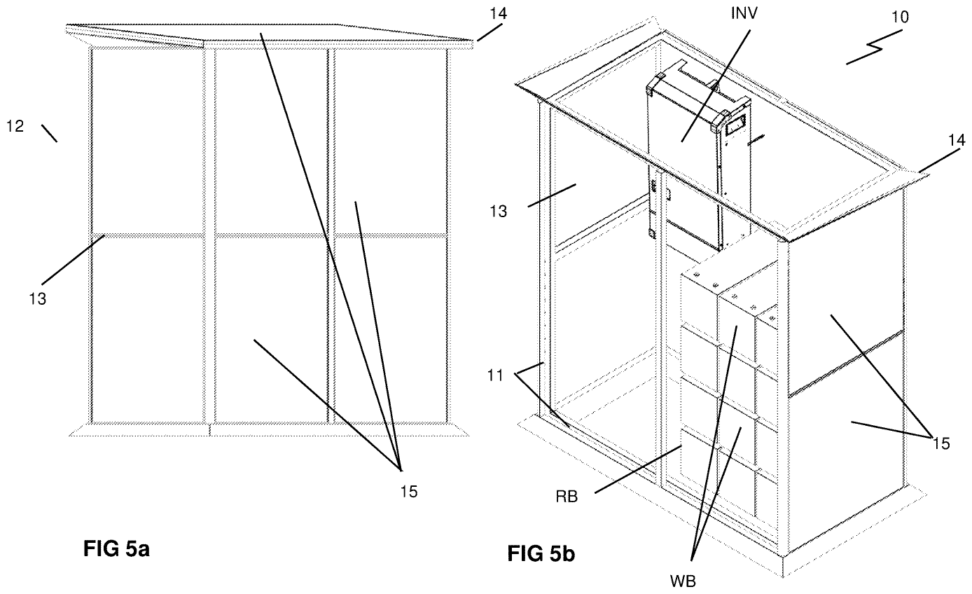

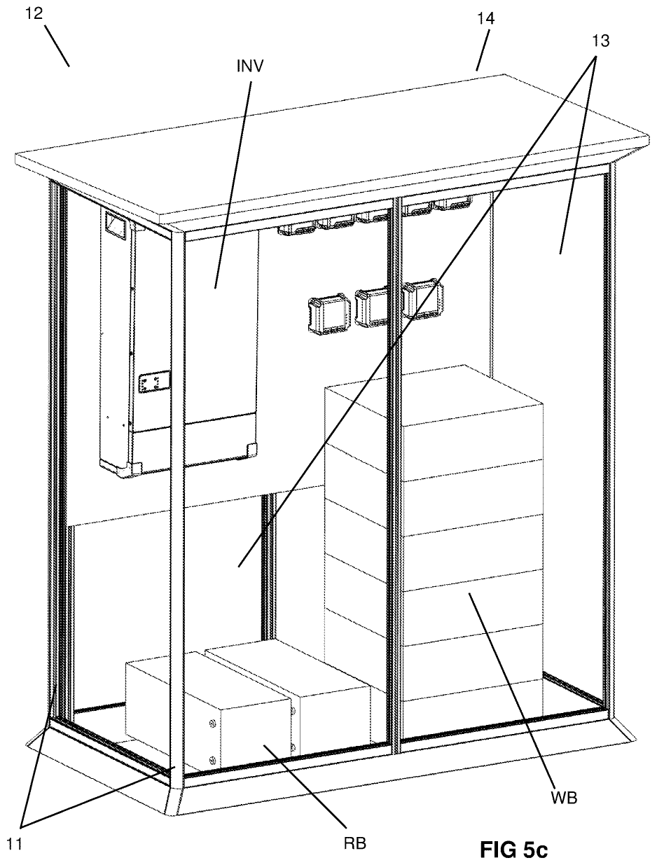

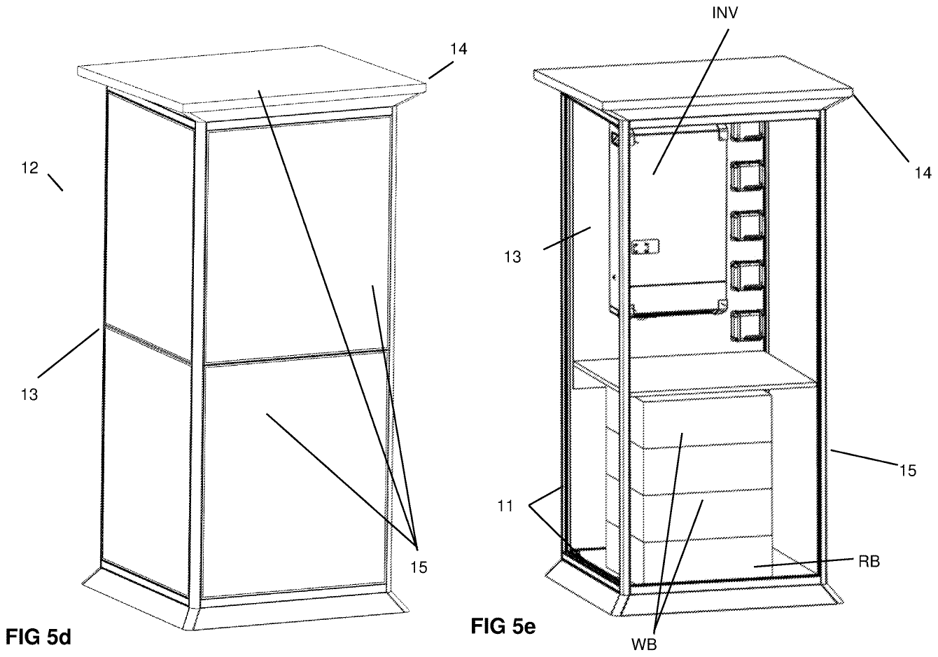

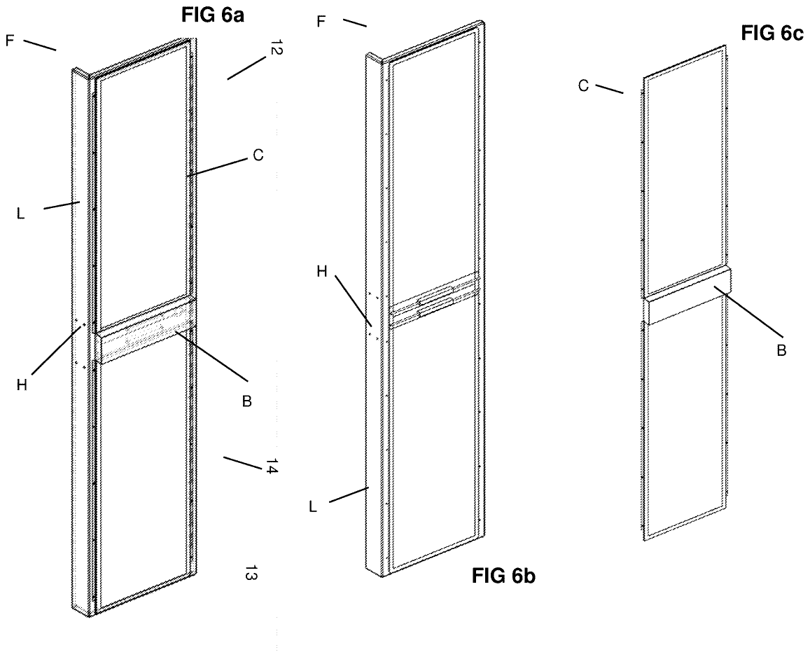

FIGS. 5a and 5b show a cabinet 10 similar to that of FIG. 3 having a larger capacity and an internal structural frame 11. As before, each of the walls 13 has attached to thereto a solar panel 15, ideally mounted with a panel frame (as shown in FIGS. 6a to 6c) which is fixed to structural frame elements 11 of the cabinet 12. A roof section 14 is disposed at an angle with respect to the front or rear face so to optimise solar harvesting ensuring optimal conditions in the summer months.

The cabinet is so sized and shaped as to accommodate standard batteries to form the reserve bank RB and working bank WB. Lithium-based batteries (such as lithium ion or lithium iron phosphate batteries) are used as the working cells and are provided in sufficient quantities to ensure that less than 40% depth of discharge is reached every day during the sub-optimal solar harvesting period (particularly in winter), to maximise cell longevity (each battery lasting anywhere between 25 and 40 years).

Stacking the batteries of the working bank WB and connecting them in a 4S3P configuration (that is, four batteries in series and three in parallel) delivers a maximum storage capacity of 33 kWh and a maximum power output of 15 kW (240 Volts, 60 Amps from 48V, 312 Amps) via the wall-mounted inverter INV.

The embodiment described finds utility in many guises and may be used as a hybrid grid charging cabinet having integrated solar generation.

FIG. 5c illustrates a minor but important modification to the arrangement of this embodiment of solar generator enclosure in which the working bank is arranged as a linear stack. In a preferred construction, a standard 19-inch rack structure may be used and selected components, such as lithium battery packs, inverters and charge controller circuits may be packaged for simple demountable connection within a rack.

FIGS. 5d and 5e exemplify a further construction of the first embodiment of solar power generator enclosure in which the internal frame 11 provides support for standard industrial rack-mounted components, such as rack-mountable lithium packs as noted above. As production is scaled, the availability of reliable, inexpensive and potentially “plug and play” component modules become standardised, power connections including ground connections to the frame elements, will facilitate ready expansion of the capacity of the enclosures of the invention. As noted below, the invention may be provided in a “kit of parts” form, allowing a purchaser to select minimum operating components and to increase capacity, add reserve bank batteries or incorporate external sources of energy, as desired.

In the illustrated embodiments, the charge controllers 16 and the inverter INV are mounted to a back panel (with 10 cm clearance around the inverter), however, these components may be provided as rack-mounted alternatives.

The enclosure may include sheet aluminium or steel panels to which the PV panels are fixed. This facilitates the direct attachment of PV panels to the enclosure. Alternatively, the PV panels are mounted within frames which are then secured to the sheet panels of the enclosure. In the most preferred constructions, PV panels mounted within rigid frames form the front, rear and side faces (and ideally the roof section) of the enclosure.

FIGS. 6a to 6c show panel frame components F for retaining a pair of PV panels. A first construction of panel frame includes a lip region L for mounting the panel to an existing face sheet to the enclosure and fixing holes H through which tamper-proof bolts may be secured. A PV panel cover section C includes a folded box structure B to provide cable routing from the PV panels to the charge controllers 16 within the enclosure.

In the preferred constructions of the first embodiment of the invention, the frame elements 11 comprise extruded profiles of aluminium or steel joined together at 90 degree angle joints to form an outer frame. As noted above, internal racking may be utilised and form part of the structural integrity of the enclosure. Solar panels are sited within a peripheral frame component and attached to it via shelving pins that locate the panels within a recess of the extrusions. This method of assembly allows panels to be installed vertically into a pre-assembled frame.

A base component, such as that illustrated in FIGS. 5a to 5e, may be made from thermoplastic polyurethane (TPU) within which holes are formed to allow the internal frame to be secured thereto to form the core of the internal frame shape. Additionally, there are ground fixing holes to allow the base to be secured to the ground or a concrete slab via appropriately rated bolts. As noted above, ground screws can be used to secure the station cabinet. A vent in the base component allows for air to enter the cabinet from the base and is protected by a mesh to prevent ingress of insects. A water drainage hole with mesh protection may also be provided for water ingress or condensation forming within the cabinet.

The roof section 14 or optional roof PV panel 15 is joined to the internal frame via a TPU form which can be covered separately with external coloured composite aluminium panels to achieve a desired aesthetic.

The inverter INV may be mounted in the top left or right corner of the cabinet with 10 cm or greater clearance around it in all directions. Batteries are stacked vertically in the internal area opposite to the inverter to ensure any escaping gases from the batteries do not affect the inverter.

To extract maximum energy from the respective PV panels 15, Maximum Power Point Tracking (MPPT) controllers are provided for each PV panel covered face of the cabinet. The controllers 16 are located above the batteries on a fire-resistant backboard. Circuitry, such as a monitoring unit 19, balance the charge rate of the batteries may also be located on the backboard.

Brushless motor driven DC fans are installed within the roof TPU form component of the cabinet. Fans in combination with vents to the base and in the top of the cabinet ensure air can flow rapidly if required from the base of the cabinet to the top and atmosphere to keep internal equipment cool. The fans are triggered by a temperature sensor with a pre-set threshold.

A central LED light strip can be used to indicate visually the current status of the cells within the cabinet, their capacity level and their charge or discharge level, as well as provide a visual alert to users of any issues that may need investigating.

Panels are optionally joined together via 3D printed joints that secure within the corner of each aluminium frame interior of each solar panel face and have a central hub that bolts them together to form a strong network of connections across the face. These can be optionally hinged to allow the panels on each face to open in a concertina fashion to allow full access to the inside equipment.

Insulation can be installed within the panel apertures to provide an improved stability of temperature within the structure.

The aperture between the angled roof panels and the side and front panels can be lit with an LED light strip to indicate charge status and solar yield via changing colour and patterns.

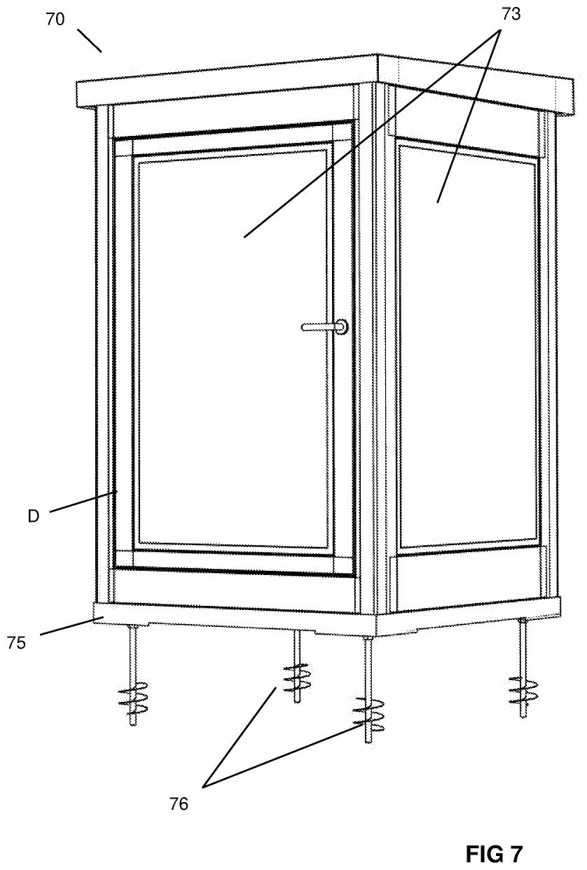

The generator apparatus of the invention may be constructed as a remote monitoring station for providing power to air or water sampling apparatus and associated transmission thereof via a communications module. In FIG. 7, the remote monitoring station 70 is constructed to house a test facility and includes a door D for access to authorised personnel. PV panels 73 are mounted on all major faces including the door and ideally also on the roof section. The monitoring station is mounted into a base plate 75 from which ground screws 76 fixed at each corner of the base plate 75 secure the station 70 in place.

It will be appreciated from the foregoing that a number of ground fixing methodologies may be utilised and that larger power generation installations may require a load-bearing bed or concrete pad.

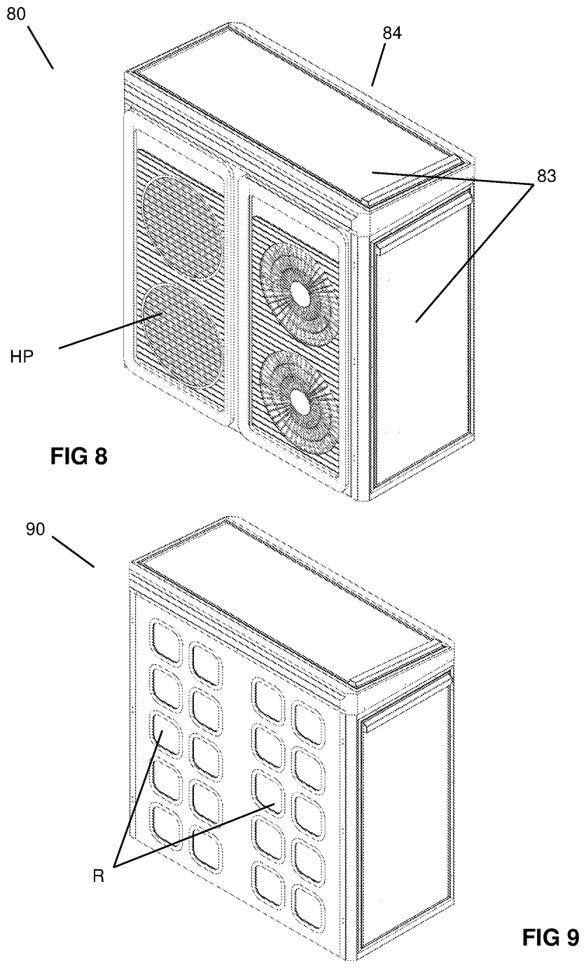

In many domestic homes gas-fired central heating is being replaced by ground source or air source heat pumps and legislation in a number of jurisdictions precludes the supply of town gas to new-build properties. It is a generally underappreciated fact that heat pumps consume significant power and may have a significant financial impact on users. A modified power generator 80 of the invention may be integrated with a heat pump HP as shown in FIG. 8 to attenuate the costs of use. PV panels 83 are positioned on all available major faces including the roof section 84. To avail of the optimum configuration for harvesting solar radiation, the heat pump vents are disposed on the face directed away from the arc subtended by the sun.

A variant of the power generating apparatus comprising a charging station 90 is shown in FIG. 9, in which the face presented away from the arc subtended by the sun is replaced by a face within which a plurality of battery receptacles R are provided. Each receptable is adapted to receive a removeable EV battery, for example, from an electric motorcycle, bicycle or foot scooter. Where the charging station 90 is commissioned by a single manufacturer, the receptacles may include a charge coupling which connects directly to the EV battery. This arrangement facilitates a battery-swap scheme, where a fully charged battery may be retrieved from a receptacle when a receptacle door is released after verification that a valid and rechargeable battery has been deposited and payment verification has been made. In other circumstances, terminal connections may be provided for a range of batteries, however, charging will only commence after the receptable door is closed and, where provided, payment verification has been made. To facilitate card payments, a communications module for verification of payment may be mounted within the cabinet. In a preferred arrangement, battery charging is accelerated for newly deposited batteries and batteries which have been fully charged become part of the working bank WB or reserve bank RB according to predetermined charging criteria.

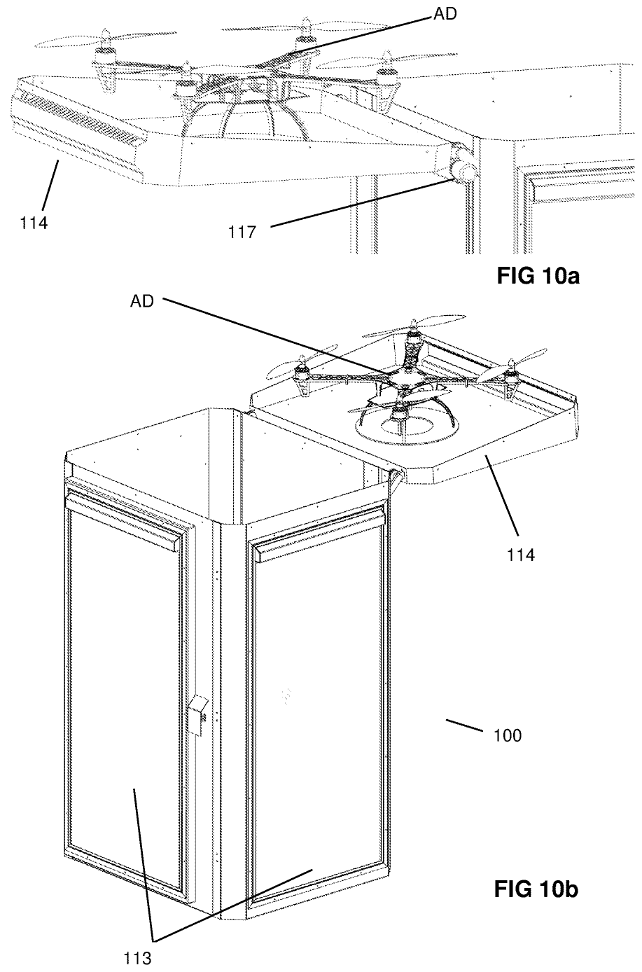

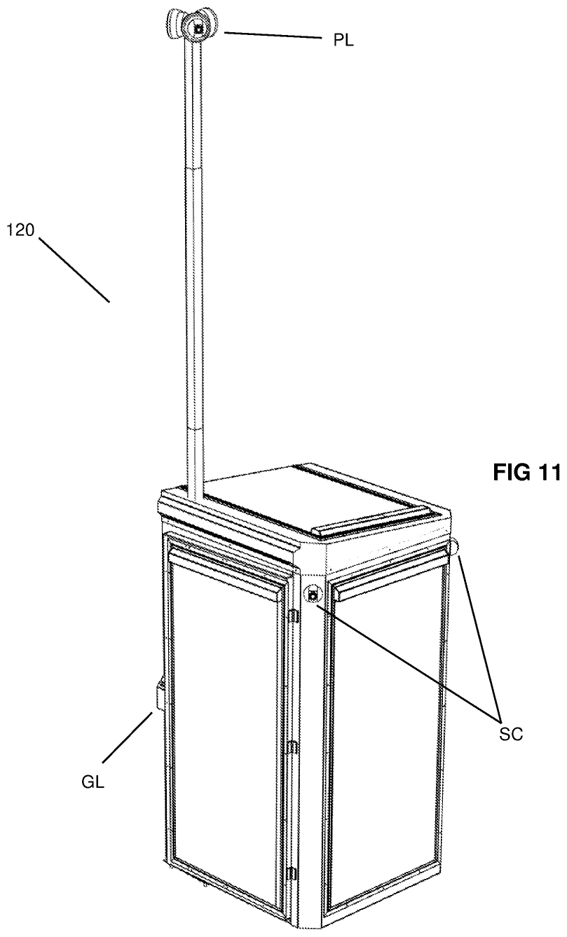

FIGS. 10a and 10b show a generator apparatus 100 which includes a landing and charging platform for an autonomous vehicle such as an aerial drone AD. The roof section 114 of the cabinet is adapted to pivot open around a motor-driven shaft 117. The drone is locked magnetically to the inner side of the roof section from which it may be deployed when release power is applied to disable the magnetic lock. Charging of the drone battery is wireless via inductive coupling. During deployment of the drone, the roof section is closed to avoid shading of the PV panels 113 and allow for further charging via the roof section PV panel where provided.

FIG. 11 shows a generator apparatus 120 having enhanced security features which include cameras SC mounted on minor faces of the cabinet and a reinforced guarded lock GL. In one construction as illustrated, a camera platform PL is mounted on a pole which is ideally telescopically extendable from the cabinet interior optionally deployable from within the cabinet by pivoting the roof section in a manner similar to that shown in FIGS. 10a and 10b.

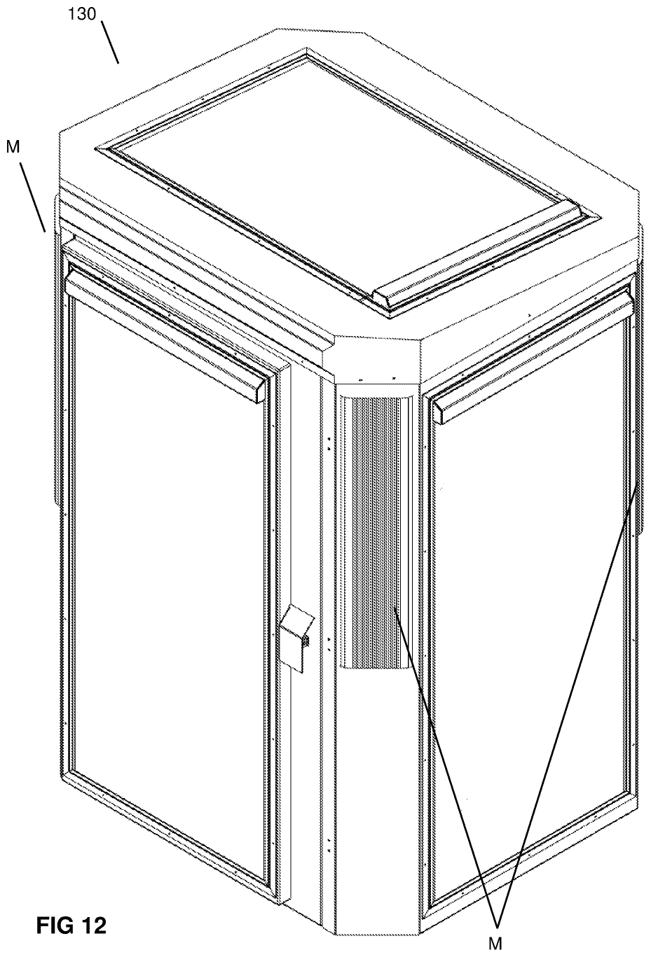

Finally, with respect to FIG. 12, a generator apparatus 130 which can include any of the configurations described or as shown in the accompanying drawings has mounted on at least one minor face of the cabinet housing, a communications module. In the construction shown, cellular base station modules M are disposed on each of the minor corner faces. Additional circuitry associate with the or each module is housed within the cabinet.

The invention yet further provides a kit of parts for a generator unit assembly system, the kit of parts comprising:
a selected number of PV panels mounted within frames in a selected configuration;
a charge controller rated to the maximum voltage and current generated for each presented face of the framed panels to match the power conversion algorithms of the controller; and
a manual isolating switch, automatic circuit breakers, fusing and bus bars to provide selected and fault-triggered isolation and operationally aggregate charge from the charge controllers to battery cell terminals.

Advantageously, the PV panels include toughening layers on all faces to maximise indirect yield of solar radiation.

The frames may comprise stainless steel for rigidity and strength or profiled aluminium for a combined characteristic of strength with lightweight.

Ideally, pairs of PV panels are mounted in a single frame and electrically connected in series to maximise the generated voltage.

The kit of parts further provides, for high demand applications and where AC power is required:
a discrete DC charge controller; and
an inverter with manual isolation switch.

Optionally, there is additionally provided a first working battery bank and a reserve battery bank.

In the preferred arrangement, the reserve battery bank comprises AGM batteries provided in a configuration associated with the required system voltage, for example, 4S3P for a 12v system, and the working battery bank comprises lithium-based batteries, such as those based on lithium ion or lithium iron phosphate cell technology, provided, if appropriate, in a configuration associated with the system voltage, for example, 4S1P.

The isolated DC charge controller is rated to charge at twice the maximum load when transferring energy from the AGM battery bank to the lithium bank.

The inverter is rated up to 15 kW to convert energy from the working bank to AC for distribution via Ingress Protection (IP) rated outlets. Support for automatic load protection and standby power mode to reduce background energy usage.

For utilisations involving consistent, year-around usage with either AC or DC powered devices:
the deep discharge working bank (lithium batteries) is sized to 250% of the maximum daily power (Wh) load to ensure a bias towards discharging the working cells to less than 40% of capacity thereby maximising their service life.

For utilisations servicing multiple low-load devices (rather than fewer high-load devices) a unitary device combining a solar charge controller and inverter is provided per-device output (in effect, one per PV panel face), with standby mode functionality to minimise background load.

It will of course be understood that the invention is not limited to the specific details described herein, which are given by way of example only, and that various modifications and alterations are possible within the scope of the appended claims.

1. A photovoltaic (PV) power generator apparatus on which fixed flat PV panels operably form at least two of the major vertical faces thereof to optimise physically and electronically the harvesting of solar radiation in sub-optimal conditions with respect to diurnal and seasonal variances of direct and indirect incidence of solar radiation., the generator comprising:
a cabinet housing defining said major vertical faces and a roof section thereof, the cabinet housing having structural frame elements and a ground-engaging element attached thereto;
sealingly disposed within the housing control circuitry for regulating the electrical energy generated via the PV panels and energy accumulators connected to the control circuitry,
in which at least two PV panels are disposed on said major vertical faces of which at least one is directed towards the path followed by the sun (due south in northern latitudes) and at least one is disposed substantially perpendicular thereto
whereby for reduced mechanical and financial overhead obviating the complexity associated with mobile and tracked arrangements, the harvesting of PV energy is physically optimised across all seasonal and diurnal variances by virtue of the orientation and location of the PV panels on the major faces of the apparatus.

2. A photovoltaic (PV) power generator apparatus as claimed in claim 1, in which PV panels are disposed on each of said major vertical faces.

3. A photovoltaic (PV) power generator apparatus as claimed in claim 1, in which there is provided a PV panel mounted on the roof section, the roof section PV panel being unitary and extending over the major face facing away from the path followed by the sun.

4. A photovoltaic (PV) power generator apparatus as claimed in claim 1, in which a PV panel mounted on the roof section is pitched towards an optimal tilt angle (TW) for PV energy generation at winter equinox (EW).

5. A photovoltaic (PV) power generator apparatus as claimed in claim 1, in which the structural frame elements are integrally formed with the PV panels.

6. A photovoltaic (PV) power generator apparatus as claimed in claim 1, which the energy accumulators comprise a bank of batteries having deep-cycle characteristics and a bank of batteries having high power delivery characteristics and wherein combining cell technologies with charge controllers and voltage monitoring circuitry optimises both charging and delivery of power in sub-optimal conditions.

7. A photovoltaic (PV) power generator apparatus as claimed in claim 1, in which the cabinet housing has a box-like form in which structural frame components provide the peripheral corners thereof and the PV panels are secured therebetween.

8. A photovoltaic (PV) power generator apparatus as claimed in claim 1, any one of the preceding claims in which the total surface area of PV panel is optimised to generate a daily average power output of at least 200 Wh.

9. A photovoltaic (PV) power generator apparatus as claimed in claim 1, in which the generator apparatus includes a communications module.

10. A photovoltaic (PV) power generator apparatus as claimed in claim 1, in which the generator apparatus includes payment verification means.

11. A photovoltaic (PV) power generator apparatus as claimed in claim 1, in which each PV panel is attached to the housing by a demountable frame adapted to encapsulate the PV panel and provide routing for cables associated with each panel.

12. A photovoltaic (PV) power generator apparatus as claimed in claim 1, in which the structural frame elements comprise extruded profiled components having rebates and channels to accommodate and retain PV panels and associated cabling.

13. A photovoltaic (PV) power generator apparatus as claimed in claim 1, in which the structural frame elements releasably retain the PV panels and include hinge elements at their peripheries to facilitate access to the interior of the enclosure.

14. A photovoltaic (PV) power generator apparatus as claimed in claim 1, in which each face having a PV panel thereon has associated therewith a dedicated and appropriately rated charge controller to manage the solar power harvested from each panel within a face to maximise the efficiency of the charging output generated.

15. A photovoltaic (PV) power generator apparatus as claimed in claim 1, in which the energy accumulators deliver a direct current (DC) power output to devices or a local power connector or via an inverter to provide an alternating current (AC) power output.

16. A kit of parts for a photovoltaic (PV) power generator apparatus of the type claimed in claim 1, the kit of parts comprising:
a selected number of PV panels mounted within frames in a selected configuration for optimisation of PV energy generation at a predetermined location;
a charge controller rated to the maximum voltage and current generated for each presented face of the framed panels to match the power conversion algorithms of the controller; and
a manual isolating switch, automatic circuit breakers, fusing and bus bars to provide selected and fault-triggered isolation and operationally aggregate charge from the charge controllers to battery cell terminals,
whereby for reduced mechanical and financial overhead obviating the complexity associated with mobile and tracked arrangements, the harvesting of PV energy is physically optimised across all seasonal and diurnal variances by virtue of the orientation and location of the PV panels on the major faces of the apparatus.

17. A kit of parts as claimed in claim 16, in which the PV panels include toughening layers on all faces to maximise indirect yield of solar radiation and the panel frames comprise extruded profiles of stainless steel for rigidity and strength or of aluminium for a combined characteristic of strength with light weight.

18. A kit of parts as claimed in claim 16, in which pairs of PV panels are mounted in a single frame and electrically connected in series to maximise the generated voltage.

19. A kit of parts as claimed in claim 16, in which the kit of parts further provides, for high demand applications and where AC power is required:
a discrete DC charge controller; and
an inverter with manual isolation switch.

20. A kit of parts as claimed in claim 16, in which there is additionally provided a first working battery bank comprising lithium ion or lithium iron phosphate batteries and a reserve battery bank comprising Absorbent Glass Mat (AGM), sodium ion cells or hybrid cells, each provided in a configuration associated with the required system voltage.

21. A kit of parts as claimed in claim 16, in which, for applications involving consistent, year-around usage with either AC or DC powered devices:
a deep discharge working bank is sized to 250% of the maximum daily power (Wh) load to ensure a bias towards discharging the working cells to less than 40% of capacity to maximise their service life longevity.

22. A kit of parts as claimed in claim 16, in which, for applications for servicing multiple low-load devices (rather than fewer high-load devices), a combined solar charge controller and inverter is provided per devices, that is one per PV panel face, with standby mode function to minimise background load.
